(19) United States
(12) Patent Application Publication
(10) Pub. No.: US 2004/0059833 A1
(43) Pub. Date: Mar. 25, 2004

(54) Method and device for delivering data

(75) Inventors: Fabio Giannetti, Bristol (GB); Roger Brian Gimson, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 10/668,959

(22) Filed: Sep. 24, 2003

(30) Foreign Application Priority Data
Sep. 24, 2002 (GB) 0222217.2

(51) Int. Cl. G06F 15/16

(52) U.S. Cl. 709/246

(57) ABSTRACT

A method of delivering data stored within a network to two or more data-handling devices having different data handling capabilities, the method comprising the steps of authoring the data to produce authored data and storing it in at least one location within the network, generating adapted data by adapting the authored data by at least structuring the authored data to provide at least a preferred and an alternative version of the adapted data, each version suitable to make the data suitable for handling by at least one of the at least two data-handling devices, storing the adapted data at a location within the network and upon receipt of a request for the data, augmenting one of the preferred or alternative versions of the adapted data with dynamically generated data and delivering the adapted data augmented with the dynamically generated data to at least one data-handling device.

### FIELD OF THE INVENTION

This invention relates to a method and related apparatus for delivering data to at least two data-handling devices

### BACKGROUND OF THE INVENTION

Access to web pages on the World Wide Web (WWW) is one example of prior art for this invention and it is currently possible to gain access to a web page using a number of different devices, such as a desktop or laptop computer, a personal digital assistant (PDA), a web enabled television or directly to a mobile telephone. Thus, in principle, data posted on a web page, such as text and graphics is accessible by a consumer in possession of any one of these devices who is able also to avail themselves of the requisite network links. In practice however a significant (but to the lay person apparently trivial) difficulty exists in disseminating data to all of these devices in a manner which is useable by a consumer: the device the consumer is using to make manifest the data may not be capable of manifesting elements of the data essential for comprehension of the information within it. Specifically for example a web page may not have been authored specially to enable viewing of its data on devices with a low capability such as a mobile telephone display (which are generally small monochrome and low resolution screen). If the author of the web page has therefore created the web page so that all or part of the essential information on the page required by the user is “coded” in the form of photographs, coloured text or animations and the like, then a user who is unable to fully display these elements of the data on their screen may effectively be unable to access the web page in any meaningful manner.

This problem is known, and is currently addressed in a number of different manners. According to one approach, data for a web page (for example) is authored independently of a consideration of the device on which the data is to be handled, other than perhaps to the extent that the author attempts to encode all important information in a manner which even the crudest form of device can handle. Once a request for a copy of the web page is received, an adaptation process, performed by a program which intermediates between the device which is to receive the data and the host device where the data is stored then takes place, in which an abridged version of the data appropriate to the device to which data is to be sent is extracted from the original data for the web page in question, and is sent to the receiving device.

A second approach involves authoring the page using computer code to author the data which is specifically appropriate for a particular class of requesting device (for example using hyper-text markup language Html) to author web pages for consumption by conventional desktop or laptop computers, which may mean having to author the page several times in order to enable manifestation of the page on several differing classes of device. In what may be termed a sub-class of this approach, data authored in a language specifically appropriate for one device is transformed into a language specifically appropriate to another class of device, possibly resulting in an unwanted loss or alteration of data as a result (in a manner analogous to the result of translating, for example, a German document into English using computer software).

The present invention tries to overcome or at least reduce the problems of the prior art.

### SUMMARY OF THE INVENTION

According to a first aspect of the invention there is provided a method of delivering data to any of two or more data-handling devices having different data handling capabilities, the method comprising the steps of:

i: structuring an initial portion of the data to provide at least a preferred and an alternative version of the initial portion of the data, each version suitable to make the data suitable for handling by at least one of the at least two data-handling devices;

ii: storing the versions of the initial portion of the data; and

iii: upon receipt of a request for data, adapting one of the preferred or alternative version of the initial portion of the data by augmenting the data with dynamically generated data and delivering the initial portion of the data augmented with the dynamically generated data to at least one data-handling device.

Such a method is advantageous because it may provide a mechanism that allows a layout to be tailored to data of differing lengths, unknown nature at the time of creation of the initial portion of the data, or other similar situations. The preferred and alternative layouts may be tailored to data having different lengths, etc. and having at least two different versions of the initial portion of the data may provide flexibility in how the initial portion of the data can incorporate the dynamically generated data. A further advantage of the method is that it may allow an author to arrange the initial versions such that the data augments as desired with the dynamic data.

In some embodiments, the preferred version of the initial data may be initially augmented with the dynamic data and sent to the data-handling device. If an error message is received from the data-handling device that it could not handle this data the method may then augment an alternative version of the initial portion of the data with the dynamic data and send this to the data-handling device.

In alternative, or additional embodiments, the method may determine which of the versions of the initial portion of the data should be augmented with the dynamic data before augmentation takes place. Such embodiments may use a model of the dynamic data to determine which of the versions should be used. Such a method may prove more efficient than embodiments which iterate towards the correct version and as such may be more advantageous.

Advantageously, the method may ensure that there is at least a single version of the initial portion of the data provided for each of the data-handling devices to which data may sent which when augmented with the dynamic data allows that data to be handled by the data-handling device.

According to a second aspect of the invention there is provided a computing device capable of delivering data to any of two or more data-handling devices having different data handling capabilities, the computing device comprising a receiving means for receiving a request for data, a transmitting means arranged to transmit data, a processing means arranged to process data and a storage means for storing data said storage means being arranged to hold at least an initial portion of the data as a preferred and an alternative version, and further the device being arranged such that when the receiving means receives a request for data the processing means is arranged to augment one of the preferred or alternative version of the initial portion of the data with dynamically generated data and send the initial data augmented with the dynamic data to the transmitting means which is arranged to transmit said initial portion of the data augmented with the dynamic data to a data-handling device.

According to a third aspect of the invention there is provided a network arranged to be capable of delivering data to any of two or more data-handling devices having different data handling capabilities, the network comprising a receiving means for receiving a request for data, a transmitting means arranged to transmit data, a processing means arranged to process data and a storage means for storing data, said storage means being arranged to hold at least an initial portion of the data as a preferred and an alternative version and further the network being arranged such that when the receiving means receives a request for data the processing means is arranged to augment one of the preferred or alternative versions of the initial data with dynamically generated data and send the initial data augmented with the dynamic data to the transmitting means which is arranged to transmit said initial portion of the data augmented with the dynamic data to a data-handling device. According to a fourth aspect of the invention there is provided a data-handling device capable of communicating with a computing device and/or network and receiving data therefrom, the data-handling device being arranged to communicate a parameter such that a method according to the first aspect of the invention can be applied to the data that is sent to the data-handling device.

The parameter may be any one of the following: the identity of the device, the model of the device, the data-handling capabilities of the device.

According to a fifth aspect of the invention there is provided a machine-readable medium containing instructions which when read by a computing device cause that computing device substantially to perform the method of the first aspect of the invention.

According to a sixth aspect of the invention there is provided a machine-readable medium containing instructions which when read by a computing device cause that computing device to function substantially as the computing device of the second aspect of the invention.

According to a seventh aspect of the invention there is provided a machine-readable medium containing instructions which when read by a computing device of a network cause that network to function substantially according to the third aspect of the invention.

According to an eighth aspect of the invention there is provided a machine-readable medium containing instruction which when read by a data-handling device cause that data-handling device to function substantially as the data-handling device according to the fourth aspect of the invention.

According to a ninth aspect of the invention there is provided a multi-stage adaptation method for adapting data for any of at least two data-handling devices having different data handling capabilities, the method comprising: in an off-line stage, adapting an initial portion of the data in a preferred layout and at least one alternative layouts; and in an on-line stage, upon a receipt of a request for data adapting the initial portion in one of the preferred and the alternative layouts with dynamically generated data.

According to a tenth aspect of the invention there is provided a multi-stage adaptation method for generating data for any of at least two data-handling devices having different data handling capabilities, the method comprising: in a first stage generating an initial portion of the data in a preferred format and at least one alternative formats; and in a second stage, upon a receipt for a request for data, augmenting the initial portion in the one of the preferred format and one of the alternative formats with dynamically generated data.

According to an eleventh aspect of the invention there is provided a method of delivering data to any of at least two data-handling devices having different data handling capabilities, the method comprising the step of: structuring an initial portion of the data to provide at least a preferred and an alternative version of the initial portion of the data, each version suitable to make the data suitable for handling by at least one of the at least two data-handling devices; storing the versions of the initial portions of the data; accepting payment from a user of one of said one or more data-handling devices, the user requesting data; and upon accepting the payment, adapting one of the preferred or alternative version of the initial portions of the data by augmenting the initial portion of the data with dynamically generated data and delivering the initial portion of the data augmented with the dynamically generated data to said one of said one or more data-handling devices.

According to a twelfth aspect of the invention there is provided a method of disseminating media data, hosted at a site within an information technology network, to one of a plurality of different classes of device connected to the network, the different classes of device having different capabilities for manifesting the data, the method comprising the steps of authoring the data by at least structuring the data in a manner which is independent of device on which the data is to be manifested; adapting the authored data to generate at least a preferred and an alternative adapted version of the authored data to make the data suitable for manifestation on a given class of device; storing the adapted data at a location within the network; and upon receipt of a request for a copy of the data, augmenting at least one of the versions of the adapted data with dynamic data and delivering the adapted data augmented with the dynamically generated data to at least one data-handling device.

According to a thirteenth aspect of the invention there is provided a method of delivering data to any of at least two data-handling devices having different data handling capabilities, the method comprising the steps of: authoring and storing an initial portion of the data processing the stored initial portion of the data to provide at least a preferred and an alternative layout version of the initial portion of the data, each layout version suitable to make the data suitable for handling by at least one of the at least two data-handling devices; storing the layout versions of the initial portions of the data; and upon receipt of a request for data, determining with which of the preferred or alternative layout versions of the initial portion of the data the dynamically generated data fits most appropriately and augmenting that layout version with dynamically generated data and delivering the initial portion of the data augmented with the dynamically generated data to at least one of the at least two data-handling devices.

According to a fourteenth aspect of the invention there is provided a method of delivering data to any of at least two data-handling devices having different data handling capabilities, the method comprising the steps of: structuring an initial portion of the data to provide at least a preferred and an alternative version of the initial portion of the data, each version suitable to make the data suitable for handling by at least one of the at least two data-handling devices; storing the versions of the initial portions of the data; and upon receipt of a request for data, adapting one of the preferred or alternative version of the initial portions of the data by augmenting the initial portion of the data with dynamically generated data and delivering the initial portion of the data augmented with the dynamically generated data to at least one data-handling device, wherein, said structuring uses a model of the dynamic data in order to generate the preferred and alternative versions of the initial portion of the data.

According to a fifteenth aspect of the invention there is provided a server arranged for generating data for any of at least two data-handling devices having different data handling capabilities, the server comprising: means for generating off-line an initial portion of the data in a preferred format and at least one alternative formats; means for augmenting on-line, in response to a request for data, the initial portion in the preferred or an alternative format with dynamically generated data.

The machine-readable medium of any of the aspects of the invention may be any one or more of the following: a floppy disk; a CDROM; a DVD ROM/RAM (including+RW/−RW); a hard drive; memory; any form of magneto optical disk; any form of tape; a transmitted signal (which may be an Internet download, a ftp transfer, or any other transmitted signal); a wire.

### BRIEF DESCRIPTION OF THE DRAWINGS

There now follows by way of example only a detailed description of one embodiment of the present invention with reference to the accompanying drawings of which:

FIG. 1 schematically shows the architecture of a server according to an embodiment of the invention;

FIG. 2 schematically shows a number of data-handling devices having data connections to the server of FIG. 1;

FIG. 3 schematically shows the processes provided by an embodiment of this invention;

FIG. 4 shows a flow chart outlining the processes being provided;

FIG. 5 shows the effect of the processes of FIG. 3 on data provided thereto; and

FIGS. 6 to 8 show the processes of FIG. 3 in greater detail.

### DETAILED DESCRIPTION OF THE DRAWINGS

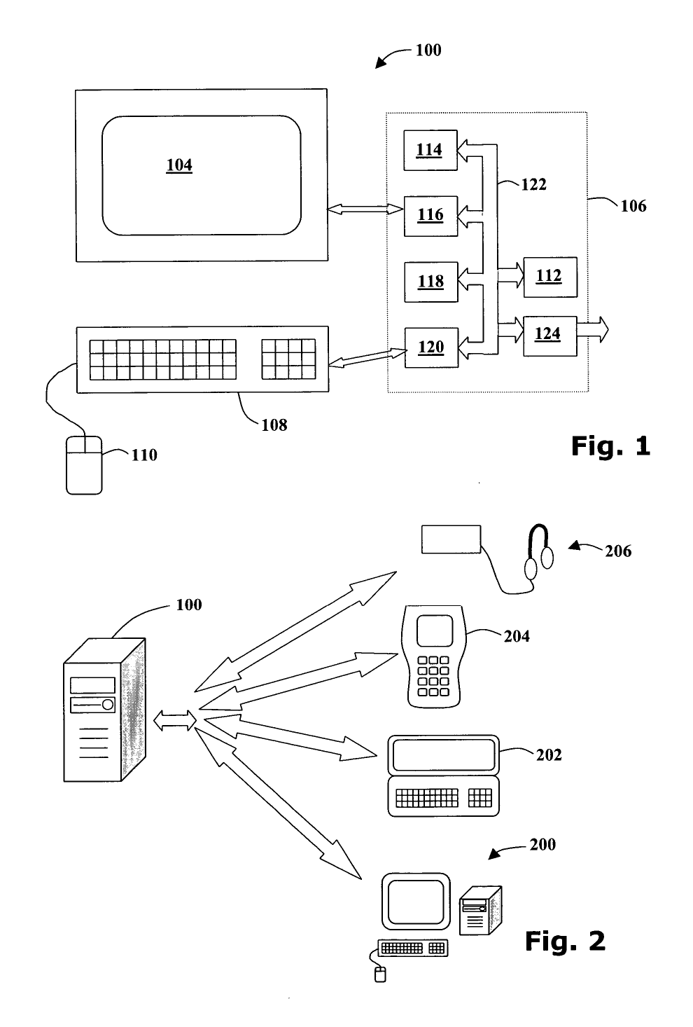

Embodiments of the invention are applicable to delivering data electronically, and in particular web content via the World Wide Web, or in short the web, although the invention does have wider application. Such data, especially that relating to the web, may be thought of as media data. Generally the data to be delivered is held on, or accessible by, a processing apparatus, or server 100, as shown in FIG. 1, and can be requested by any number of devices that are capable of communicating with the server 100. The data does not necessarily have to be sent to the device that requested the device and one device may request that data can be sent to another device.

In this embodiment the computing device, or server 100, comprises a display 104, processing circuitry 106, a keyboard 108, and mouse 110. The processing circuitry 106 further comprises a processing unit 112, a hard drive array 114, a video driver 116, memory 118 (RAM and ROM) and an I/O subsystem 120 which all communicate with one another, as is known in the art, via a system bus 122. The processing unit 112 comprises an INTEL™ PENTIUM™ series processor, running at typically between 2 GHz and 2.5 GHz. The server 100 connects to a network, which may be thought of as an Information Technology Network, via a network adapter 124, which provides a transmitting and receiving means for the server 100 and allows communication with the server 100 across a network to which the server 100 is attached.

It will be appreciated that although the computing device 100 is described as a server connected to a network it would be equally possible for the computing device to be un-networked and for transmission of data from the computing device 100 to occur over a direct connection to that computing device. The direct connection may be any form of connection suitable for transmitting data whether wireless or wired.

As is known in the art the ROM portion of the memory 118 contains the Basic Input Output System (BIOS) that controls basic hardware functionality. The RAM portion of memory 118 is a volatile memory used to hold instructions that are being executed, such as program code, etc.

The hard drive array 114 is used as mass storage for programs and other data although it is of course equally possible for data to be accessed across the network via the network adapter 124 from a remote storage means.

Other devices such as CDROMS, DVD ROMs, etc. could be coupled to the system bus 122 and allow for retrieval and/or storage of data from different media, etc.

The server 100 could have the architecture known as a PC, originally based on the IBM™ specification, but could equally have other architectures. TM The server may be an APPLE™, or may be a Reduced Instruction Set Computer (RISC) system, and may run a variety of operating systems (perhaps HP-UX, LINUX, UNIX, MICROSOFT™ NT, AIX™, or the like).

In this embodiment web content, in this case a web-site comprising a number of pages, is held on the server 100. The web content is visual information comprising text, graphics, etc. It will be appreciated that the data could also comprise sound or any other data that it may be desired to transmit.

It will be appreciated that a web-site may include static data (that is, data which is known at the time of authoring and does not vary with time) and dynamic data which may not be known with certainty until the web-site is accessed and viewed by a user which may be due to a number of different reasons. For example, the data may be time dependent in some manner, it may be specific to the location of the user (for example weather information), it may be dependent upon the identity of the user (for example bank account details), or other similar situations. By way of example, a web-site providing weather forecasts may have headings and links that remain the same from day to day, whereas the weather forecasts themselves will vary. Alternatively, the web-site may display some information that the user calls to the screen for instance the user may be accessing a database of names and addresses. While it can usually be expected that a name will be under, say, 50 characters long, this cannot be guaranteed. In the case of sound data (for example in a message over an audio link) the static data may, for example, comprise a heading announcing the data to follow (e.g. the static data may announce “telephone number” and the dynamic data may be the telephone number that has been requested.)

As a further example in which the data of the web page in the form of text (i.e. visual characters, usually alpha-numeric in any language), a web page may provide information on train times, and the opportunity to book a ticket. The data however could be in any media form consumable via the network, such as music, graphics, moving images such as film or video clips, or animations, or a book assimilable in tactile form via the network, for example in Braille, sound or any other data.

Referring now to FIG. 1 computing device 100 within a network hosts a web page which can be accessed across the network, and a processing capability which runs a program for adapting the data of web pages to devices to which the pages may be sent. In the present example this is provided by the processor 112 of the entity hosting the web page although this is not essential and the processing capability may be provided by any suitable computing entity, and at any suitable location within the network.

In the examples to be discussed in detail herein, the data of the web page is provided by an author, although this is not necessary, and is entirely incidental from the point of view of the present invention. In this context the process of authoring the web page may include the provision of a number of the parts which comprise the total data. For example, in the case of a legacy system (i.e. one having pre-existing data) to which the methods of the present invention are to be applied, the data may be authored simply by translating the pre-existing electronic structure coded into the file storing the data into a more suitable form; authoring of the data may however additionally include other authoring steps, such as actually creating the artistic work, for example.

The authored data may be static data as discussed above and provide an initial portion of data. In one embodiment this initial portion of data may be processed to create at least a preferred version and an alternative version in accordance with various device class specifications to enable it to be appropriately manifested on devices within the aforementioned classes, such as, for example, on a desktop PC 200, on a Personal Digital Assistant (PDA) 202 on a mobile telephone 204, or listened to on a headset 206, as illustrated in the schematic illustration of the process shown in FIG. 2. However, in alternative embodiments alternative and additional versions may be provided. A preferred and an alternative version are provided for each device class specification. It will appreciated that each of the devices in FIG. 2 has different data handling and indeed different data display/reproduction capabilities. Further, devices in any one particular class (for example PDA) may have different display capabilities compared with other devices of that class.

Device class specific adaptations of the data are then stored within the network, in the present example on the hard drive array 114, although this storage may once again be located at any suitable location within the network. The device class specific adaptations are stored in at least a preferred 310 and an alternative 312 version, which are used as will be explained hereinafter. In other embodiments, any number of other versions of the initial data may be generated and stored in a storage means for future use (perhaps roughly any of the following: 3, 4, 5, 6, 7, 8, 9, 10, 15, 25, 50 or more versions could be created, or any number in between).

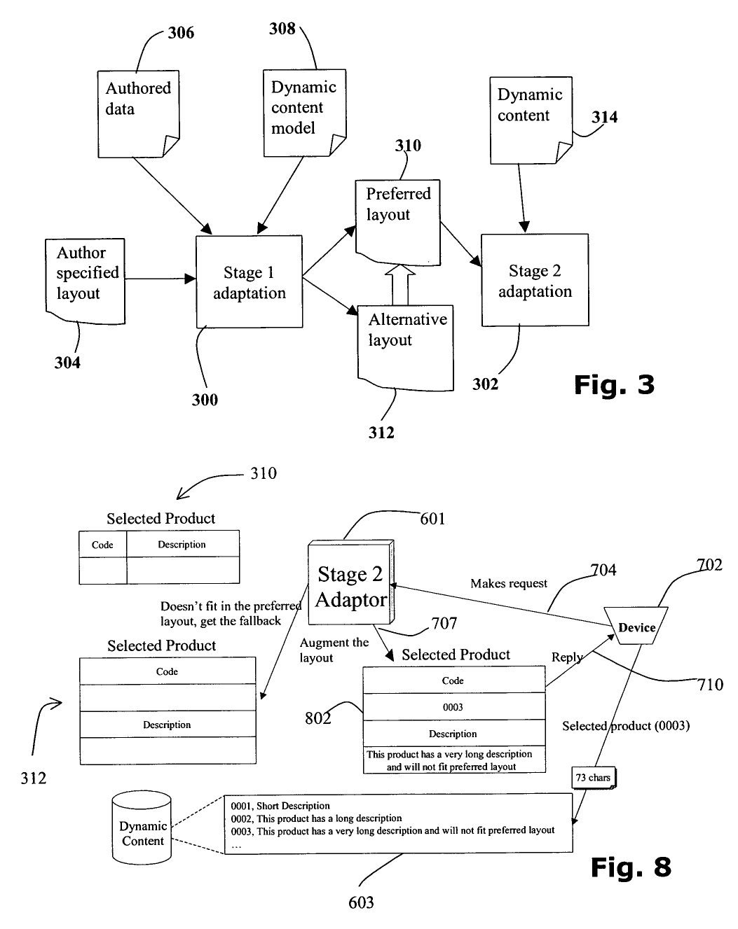

FIG. 3 provides an overview of the processes of one embodiment of the present invention and comprises two stages: stage one 300 and stage two 302. The stage one 300 process takes as its inputs an author specified layout 304, initial/authored (static) data 306 and a model 308 of the dynamic data which may be expected. The first stage process takes these inputs and generates at least a preferred 310 and an alternative version 312 of the initial portion of the data into which dynamic data 314 can be inserted by the second stage of the process 302.

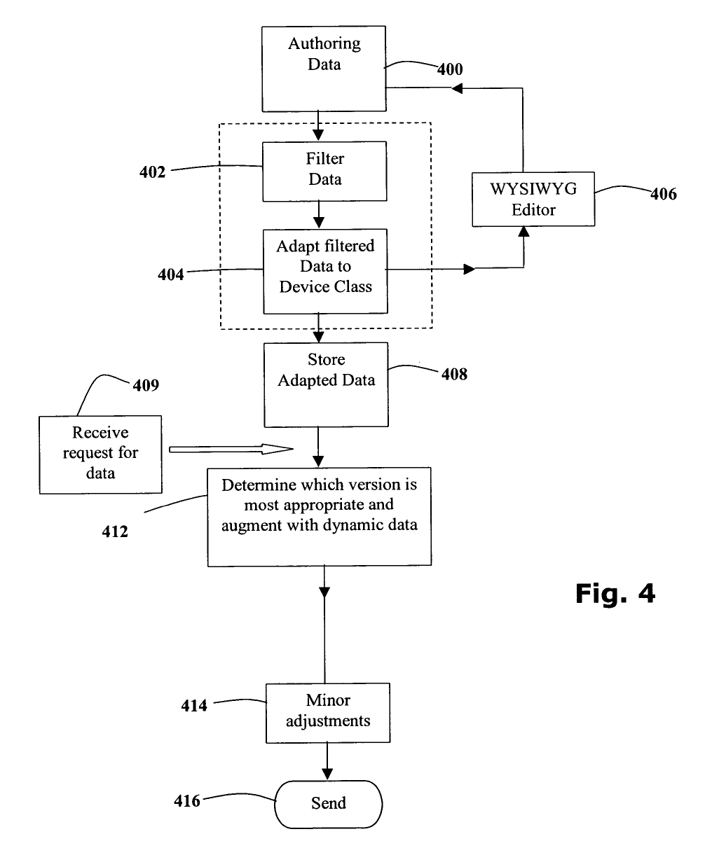

Thus, referring now to FIG. 4, in summary, an embodiment of process according to the present invention includes, at step 400 the authoring of the data to provide authored data, which at least includes the process of incorporating within the data machine-readable structure which is, generally, independent of device specification by which the data is to be handled. The process could of course be applied to authored data that was held in a device specification dependent manner.

This step is followed, at step 402, by the process of filtering the data for the particular class of device to which the data is to be handled, so that for example non-essential elements of the data can be omitted in the case of limited capability devices, and at step 404 the filtered data is adapted to the specific class of device. Preferably, when authoring the data, it is useful to have at least some idea of how the data will be handled as a result of decisions taken during the authoring process.

For the case of data-handling devices that display the data it is advantageous if the adapted data can be viewed and therefore, at step 406 the device-specific adapted data is displayed to provide this information, most preferably in What You See Is What You Get (WYSIWYG) form, so that it is readily apparent the exact manner in which the data will be displayed. However, it will be appreciated that certain kinds of data, for example audio, cannot be displayed in this manner and other mechanisms may be required to check the adaptation of such data.

In this first stage adaptation process 402, 404, 406, which may be thought of as an off-line adaptation process, two version of the initial data are generated: a preferred and an alternative. In other embodiments it would be equally possible to generate other versions. Generally, each version of the adapted data that has been created is stored in a separate file. However, it would be equally possible for the version to be stored in another manner—for example as separate portions of a single file with appropriate markings between the files, in a database, or any other suitable means.

Following device-specific adaptation, the initial data is stored at a suitable location within the network at step 408, from which it is retrieved and sent to a data-handling device on receipt of a request 409, whereupon it is augmented with the dynamic component of the data at step 412 in a second stage adaptation process. Initially an attempt is made to augment the dynamic data with the preferred version of the adapted data and at step 412 an assessment is made as to how well the dynamic data fits within the preferred version of the adapted data as will be explained hereinafter. If the dynamic data does not fit within the preferred version of the adapted data then the process flow loops and an attempt is made to fit the dynamic data to the next most preferred version of the adapted data.

In alternative embodiments, it will be possible to assess the dynamic data and determine into which version of the initial portion of the data the dynamic data should be augmented. For example, if the dynamic data were a name from a database, it would be possible to obtain the number of characters in the name and from this number determine which of the versions (preferred/alternative) would be most appropriate.

The versions of the initial data may be arranged such that there is at least one version of the initial data to which the dynamic data will fit and therefore, eventually the process should find a version of the initial portion of the data that is suitable. Thus, for example if versions of the initial data are to be provided for the PDA class of devices, it is desirable to ensure that at least one version of the initial portion of the data allows all dynamic data as specified in the dynamic data model 308 to be displayed on the PDA having the lowest display capability. This should ensure that all of the data may be displayed on all of the devices. Other methods may be used to speed the selection of the appropriate version of the adapted data rather than simply trying one after the other.

Once a version of the initial portion of the data has been selected into which the dynamic data fits minor adjustments may be made to this combination of the adapted data augmented with the dynamic data in step 414. The minor adjustments may be made as appropriate to take account of minor differences of the requesting device from that of its generic class (for example for a specific model of PDA within the class of PDA's), this process taking place at any suitable location within the network between the storage of the device specific adaptations and the requesting device, including where appropriate at either of these entities. Once any such minor adjustments have been made to the data it is transmitted to the data-handling device for which it is intended in step 416. This may of course, not be the data-handling device that requested the data.

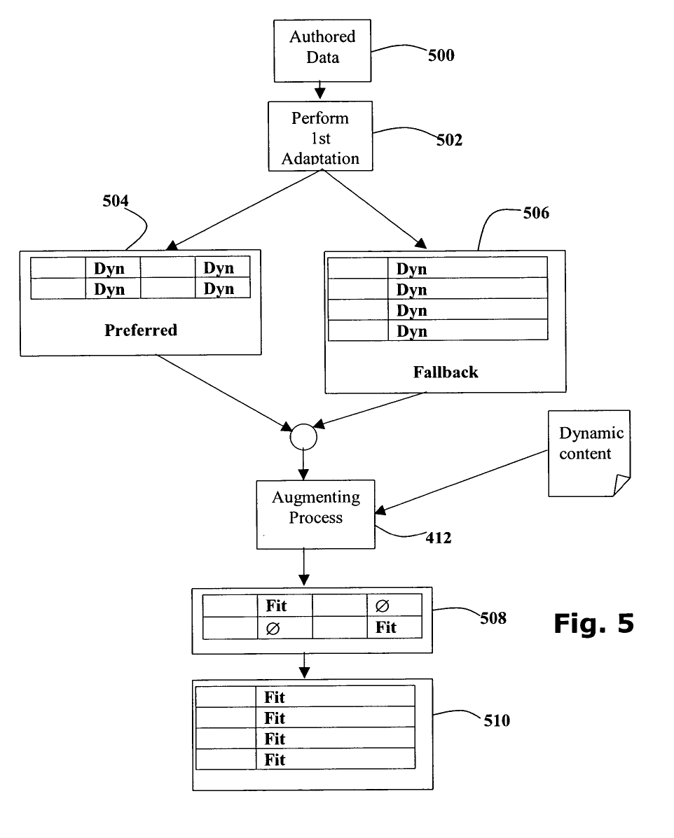

The process of determining whether the dynamic data fits within the initial data is described in relation to FIG. 5. Authored data 500 is adapted in the first stage adaptation process 502 which comprises the steps 402, 404 described in relation to FIG. 4. This generates at least a preferred 504 and an alternative 506 version of the authored initial portion of the data. The augmenting process 412 described in relation to FIG. 4 tries to fit dynamic data into the one of the versions of the adapted data, starting with the preferred version.

Looking at FIG. 5 it can be seen that in this example the preferred version 504 of the adapted data includes a table comprising two rows and four columns, whereas the alternative version 506 includes a table comprising four rows and two columns. Using x,y notation with the origin being at the lower left corner of each table, it can be seen that dynamic data is to be fitted to the four of the cells of each version of the table 504, 506. In the preferred embodiment the dynamic data is to be fitted at cells (2,1), (4,1), (2,2) and (4,2) whereas in the alternative version the dynamic data is to be fitted at cells (2,1), (2,2), (2,3) and (2,4). It will be appreciated that the width of the second column in the alternative version 506 is wider that the width of the columns in the preferred embodiment and that therefore the dynamic data is more likely to fit the table. Therefore, as illustrated at 508 in FIG. 5 although the dynamic data fits in two of the cells of the preferred versions of the adapted data (cells (2,2) and (4,1)) it does not fit in two other cells ((2,1) and (4,2)). However, as illustrated at 510 in FIG. 5 because of the greater column width the dynamic data fits in the alternative version 506 of the adapted data.

The dynamic data may be generated from a database, which will be appreciated will generally have a maximum length for any one field. However, the average length of data within that field could potentially be less than the maximum. The preferred embodiment of the adapted data may be arranged to accommodate the average, or perhaps more usefully slightly greater than the average length, of the data within that field such that it is displayed how the author intends. However, for some of the records within the database the data may be too long for the preferred version of the adapted data. In such a situation the alternative version may be used which may be arranged so that it can accommodate the longest record within the database. Of course, it would be possible to have any number of alternative versions. For example the preferred version may be able to accommodate data less than the average length and then iterate through further version until a suitable version is located.

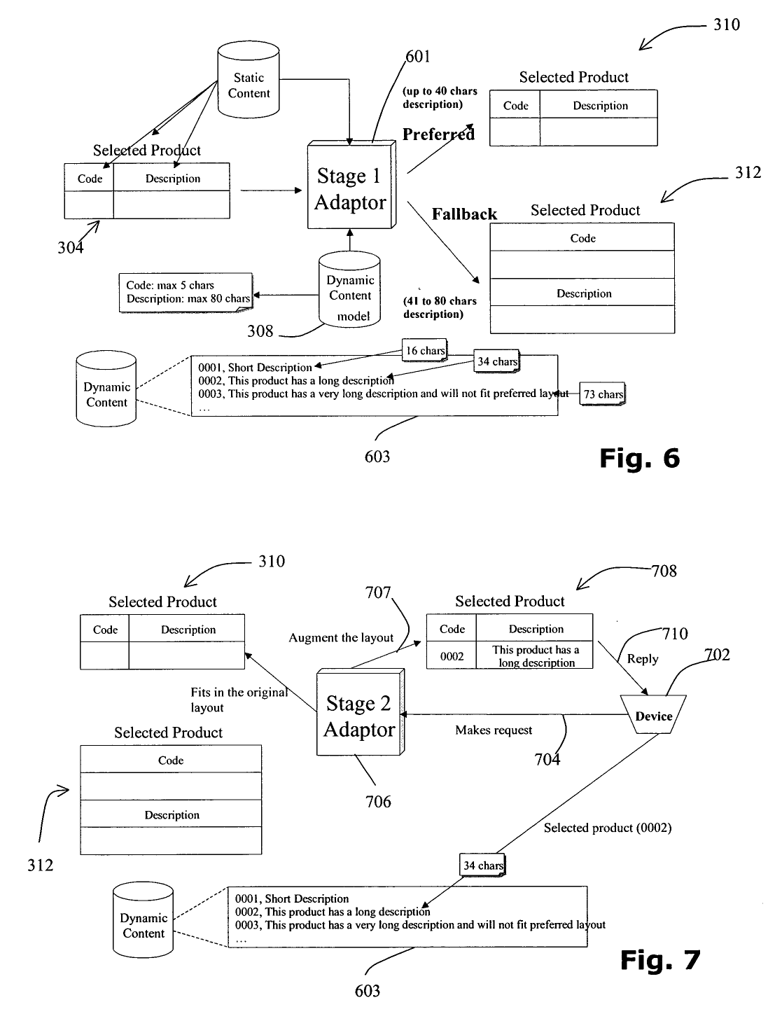

FIGS. 6 to 8 show an example implementation in which the web-page shows a product code and a description of varying length. FIG. 7 shows the case when the description is of a length such that the preferred layout can be used in presenting the information. FIG. 8 shows the case where the description is too long to be shown in the preferred layout and the fallback layout is used in its place. As FIGS. 6 to 8 correspond to FIG. 3, like features are labeled with like reference numerals.

Discussing these Figures in greater detail, FIG. 6 shows an example of a Stage 1 adaptation 300. In FIG. 6, a Stage 1 Adaptor 601 receives static content, or authored initial portion of the data 306 with the Author specified layout 304 of a 2×2 table, intended to display a product code and a description of the product associated with that code, and a title. The dynamic content model 308 states that the dynamic content will be drawn from a data source such that the product codes to be accessed will have a maximum of 5 characters, while the descriptions associated with that product may have up to 80 characters.

In the Stage 1 Adaptation 300, the Stage 1 Adaptor 601 creates two layouts, a preferred layout 310, in this example comprising a 2×2 table with a title and a fallback, or alternative layout 312, comprising a 1×4 table with a title. It also establishes that for a particular device class, the preferred layout 310 can be used provided that the description associated with a product code referenced when displaying the web site is less than 40 characters long. If the description exceeds 40 characters, then the alternative layout 312 should be used.

FIG. 6 also shows an extract 603 from the database holding the product codes and the associated descriptions. As can be seen from this extract 603, some of the descriptions are less than 40 characters long, some exceed 40 characters.

FIG. 7 shows the Stage 2 Adaptation 302, which may be thought of as an on-line adaptation process, that is performed when the description associated with a product code accessed by a user of web-site is less than 40 characters long, i.e. when the preferred layout may be used.

The device 702 (which may be any of the example devices 200, 202, 204, 206 discussed above) sends a request 704 to a Stage 2 Adaptor 706 for information relating to the product with product code 0002. This has a description 34 characters long, so the Stage 2 Adaptor augments 707 the preferred layout 310 with the dynamic data, in this case comprising the product code and the product description. The completed layout 708 is then sent 710 to the device 702.

FIG. 8 shows the Stage 2 Adaptation 302 that is performed when the description associated with a product code accessed by a user of web-site exceeds 40 characters, i.e. when the preferred layout may no longer be used and the alternative layout 312 should be used in its place.

The device 702 (which may be any of the example devices 200, 202, 204, 206 discussed above) sends a request 704 to a Stage 2 Adaptor 706 for information relating to the product with product code 0003. This has a description 73 characters long, so the Stage 2 Adaptor 706 augments the alternative layout 312 with the dynamic data, again comprising the product code and the product description. The completed layout 802 is then sent 710 to the device 702.

In some embodiments a charge may be made for delivering data to a data-handling device. Payment may be required before data is delivered to the data-handling device. Payment mechanisms will be familiar to the person skilled in the art but may include any of the following: debiting a user account; credit card payments; reversed charged text messages; micro-payment mechanism, etc.

What we claim is:

1. A method of delivering data to any of two or more data-handling devices having different data handling capabilities, the method comprising the steps of:
i: structuring an initial portion of the data to provide at least a preferred and an alternative version of the initial portion of the data, each version suitable to make the data suitable for handling by at least one of the at least two data-handling devices;
ii: storing the versions of the initial portions of the data; and
iii: upon receipt of a request for data, adapting one of the preferred or alternative version of the initial portions of the data by augmenting the initial portion of the data with dynamically generated data and delivering the initial portion of the data augmented with the dynamically generated data to at least one data-handling device.

2. A method according to claim 1 which further comprises an initial step of authoring and storing the initial portion of the data and processing this stored initial portion to generate the at least the preferred and alternative versions of the initial portion of data.

3. A method according to claims 1 in which the dynamic data is generated from any one or more of the following: a database; a newsfeed; any suitable store of machine-readable data.

4. A method according to any of claims 1 in which the method determines with which version of the initial portion of the data the dynamically generated data fits most appropriately and augments that version with the dynamic data.

5. A method according to claim 1 which uses a model of the dynamic data in order to generate the versions of the initial portion of the data.

6. A method according to claim 1 which ensures that there is at least one version of the initial portion of the data that is suitable to augment with the dynamic data to create data that is suitable to send to a data-handling device having the lowest capabilities that can receive data.

7. A method according to claim 1, wherein the alternative version of the initial portion of the data is structured to accommodate a different amount of dynamic data than the preferred version of the initial portion of the data.

8. A multi-stage adaptation method for adapting data for any of at least two data-handling devices having different data handling capabilities, the method comprising:
i: in an off-line stage, adapting an initial portion of the data in a preferred layout and at least one alternative layouts; and
ii: in an on-line stage, upon a receipt of a request for data adapting the initial portion in one of the preferred and the alternative layouts with dynamically generated data.

9. A multi-stage adaptation method for generating data for any of at least two data-handling devices having different data handling capabilities, the method comprising:
i: in a first stage generating an initial portion of the data in a preferred format and at least one alternative formats; and
ii: in a second stage, upon a receipt for a request for data, augmenting the initial portion in the one of the preferred format and one of the alternative formats with dynamically generated data.

10. A method of delivering data to any of at least two data-handling devices having different data handling capabilities, the method comprising the step of:
i: structuring an initial portion of the data to provide at least a preferred and an alternative version of the initial portion of the data, each version suitable to make the data suitable for handling by at least one of the at least two data-handling devices;
ii: storing the versions of the initial portions of the data;
iii: accepting payment from a user of one of said one or more data-handling devices, the user requesting data; and
iv: upon accepting the payment, adapting one of the preferred or alternative version of the initial portions of the data by augmenting the initial portion of the data with dynamically generated data and delivering the initial portion of the data augmented with the dynamically generated data to said one of said one or more data-handling devices.

11. A method of disseminating media data, hosted at a site within an information technology network, to one of a plurality of different classes of device connected to the network, the different classes of device having different capabilities for manifesting the data, the method comprising the steps of:
i: authoring the data by at least structuring the data in a manner which is independent of device on which the data is to be manifested;
ii: adapting the authored data to generate at least a preferred and an alternative adapted version of the authored data to make the data suitable for manifestation on a given class of device;
iii: storing the adapted data at a location within the network; and
iv: upon receipt of a request for a copy of the data, augmenting at least one of the versions of the adapted data with dynamic data and delivering the adapted data augmented with the dynamically generated data to at least one data-handling device.

12. A method according to claim 11 in which the method determines with which version of the initial portion of the data the dynamically generated data fits most appropriately and augments that version with the dynamic data.

13. A method of delivering data to any of at least two data-handling devices having different data handling capabilities, the method comprising the steps of:
i: authoring and storing an initial portion of the data
ii: processing the stored initial portion of the data to provide at least a preferred and an alternative layout version of the initial portion of the data, each layout version suitable to make the data suitable for handling by at least one of the at least two data-handling devices;
iii: storing the layout versions of the initial portions of the data; and
iv: upon receipt of a request for data, determining with which of the preferred or alternative layout versions of the initial portion of the data the dynamically generated data fits most appropriately and augmenting that layout version with dynamically generated data and delivering the initial portion of the data augmented with the dynamically generated data to at least one of the at least two data-handling devices.

14. A method according to claim 13 which uses a model of the dynamic data in order to generate the versions of the initial portion of the data.

15. A method of delivering data to any of at least two data-handling devices having different data handling capabilities, the method comprising the steps of:
i: structuring an initial portion of the data to provide at least a preferred and an alternative version of the initial portion of the data, each version suitable to make the data suitable for handling by at least one of the at least two data-handling devices;
ii: storing the versions of the initial portions of the data; and
iii: upon receipt of a request for data, adapting one of the preferred or alternative version of the initial portions of the data by augmenting the initial portion of the data with dynamically generated data and delivering the initial portion of the data augmented with the dynamically generated data to at least one data-handling device,
wherein, said structuring uses a model of the dynamic data in order to generate the preferred and alternative versions of the initial portion of the data.

16. A method according to claim 11 in which the method determines with which version of the initial portion of the data the dynamically generated data fits most appropriately and augments that version with the dynamic data.

17. A method according to claim 11 which ensures that there is at least one version of the initial portion of the data that is suitable to augment with the dynamic data to create data that is suitable to send to a data-handling device having the lowest capabilities that can receive the data.

18. A method according to claim 11 in which the dynamic data is generated from any one or more of the following: a database; a newsfeed; any suitable store of machine-readable data.

19. A method according to claim 11, wherein the alternative version of the initial portion of the data is structured to accommodate a different amount of dynamic data than the preferred version of the initial portion of the data.

20. A computing device capable of delivering data to any of at least two data-handling devices having different data handling capabilities, the computing device comprising a receiving means for receiving a request for data, a transmitting means for transmitting data, a processing means for processing data and a storage means for storing data said storage means being arranged to hold at least an initial portion of the data as a preferred and an alternative version, and further the computing device being arranged such that when the receiving means receives a request for data the processing means is arranged to augment one of the preferred or alternative version of the initial portion of the data with dynamically generated data and send the initial portion of the data augmented with the dynamic data to the transmitting means which is arranged to transmit said initial portion of the data augmented with the dynamic data to a data-handling device.

21. A network arranged to be capable of delivering data to any of at least two data-handling devices having different data handling capabilities, the network having a server, the server comprising:
a network adapter for receiving a request for data and transmitting data;
a processing unit arranged to process data; and
a memory for storing data, said memory being arranged to hold at least an initial portion of the data as a preferred and an alternative version,
the server being arranged such that when the network adapter receives a request for data the processing unit augments one of the preferred and alternative versions of the initial portion of the data with dynamically generated data and sends the initial portion of the data augmented with the dynamic data to the network adapter which is arranged to transmit said initial portion of the data augmented with the dynamic data to a data-handling device.

22. A server arranged for generating data for any of at least two data-handling devices having different data handling capabilities, the server comprising:
means for generating off-line an initial portion of the data in a preferred format and at least one alternative formats;
means for augmenting on-line, in response to a request for data, the initial portion in the preferred or an alternative format with dynamically generated data.

23. A data-handling device capable of communicating with a computing device and/or network and receiving data therefrom, the data-handling device being arranged to communicate a parameter such that a method according to claim 1 can be applied to the data that is sent to the data-handling device.

24. A data handling device, according to claim 23, wherein the parameter is any one of the following: the identity of the device, the model of the device, the data-handling capabilities of the device.

25. A machine-readable medium containing instructions which when read by a computing device cause that computing device substantially to perform the method of claim 1.

26. A machine-readable medium containing instructions which when read by a computing device cause that computing device to function substantially as the computing device of claim 20.

27. A machine-readable medium containing instructions which when read by a computing device of a network cause that network to function substantially according to claim 21.

28. A machine-readable medium containing instruction which when read by a data-handling device cause that data-handling device to function substantially as the data-handling device according claim 23.
